(19) United States
(12) Patent Application Publication
(10) Pub. No.: US 2009/0246293 A1
(43) Pub. Date: Oct. 1, 2009

(54) COMPOSITIONS AND METHODS TO CONTROL OOMYCETE FUNGAL PATHOGENS

(75) Inventors: Robert J. Ehr, Indianapolis, IN (US); Norman R. Pearson, Carmel, IN (US); Ronald Ross, JR., Zionsville, IN (US); Christian Schobert, Salem, VA (US)

Correspondence Address: DOW AGROSCIENCES LLC, 9330 ZIONSVILLE RD, INDIANAPOLIS, IN, 46268, US

(73) Assignee: Dow AgroSciences LLC, Indianapolis, IN (US)

(21) Appl. No.: 12/416,739

(22) Filed: Apr. 1, 2009

Related U.S. Application Data
(60) Provisional application No. 61/072,552, filed on Apr. 1, 2008.

(51) Int. Cl. A01N 59/20; A01N 43/90; A01P 3/00; A01N 37/18; A01N 47/28; A01N 43/40

(52) U.S. Cl. 424/632; 424/633; 514/259.31; 514/614; 514/615; 514/588; 514/315

(57) ABSTRACT

The present invention relates to compounds and the use of such compounds for increasing the efficacy of fungicides for controlling oomycete pathogen induced disease or diseases in one or more plants.

### CROSS-REFERENCE TO RELATED APPLICATIONS

This application claims the benefit of U.S. Provisional Patent Application No. 61/072,552, filed on Apr. 1, 2008, which is expressly incorporated by reference herein.

### FIELD OF THE INVENTION

This invention relates to methods and compositions suitable for controlling oomycete fungal plant pathogens.

### BACKGROUND AND SUMMARY OF THE INVENTION

During the asexual life cycle of a number of oomycete pseudo-fungi, such as Phytophthora infestans, the cause of late blight of potatoes, and Plasmopara viticola, which causes downy mildew of grapes, spores are produced by the pathogen called sporangia. Under suitable conditions, the contents of sporangia form additional spores called zoospores. Zoospores have flagella and are capable of swimming in water, i.e. they are motile. Zoospores serve as major infection agents by swimming to and encycsting near the stomata of a plant or other suitable place on the leaf, stem, root, seed or tuber for infecting the plant. On foliage, the stomata are then entered into by germ tubes from the germinating cysts or in some cases the germ tube from the encysted zoospore can directly pentrate the plant or root surface.

Past research has identified some chemicals known to attract zoospores. These zoospore attractants may generally be described as a substance or compound that causes a chemotactic response by a zoospore. Examples of zoospore attractants chemicals are disclosed in the article “Fatty acids, aldehydes and alcohols as attractants for zoospores of Phytophthora palmivora” in Nature, volume 217, page 448, by Cameron and Carlile. Further examples of zoospore attractants may be found in the articles “Biology of Phytophthora zoospores” in Phytopathology, volume 60, pages 1128-1135 by Hickman and “Chemotactic response of zoospores of five species of Phytophthora” in Phytopathology, volume 63, page 1511 by Khew. The disclosures of each of the above mentioned articles are expressly incorporated by reference herein. Generally, these zoospore attractant chemicals or substances are produced by the root region of plants and may enhance the infection process in the rhizosphere by enabling the zoospores to locate a point for infection. It is possible that plant foliage or specific sites on the foliage also produce substances that are attractive to zoospores.

Substances can be tested for their ability to attract zoospores through chemotaxis using a variety of published methods, including those employing capillary tubes that emanate the substance to be tested. Such methods are broadly applicable and are described in various publications, such as:
1. Donaldson, S. P. and J. W. Deacon. 1993. New Phytologist, 123: 289-295.
2. Tyler, B. M., M-H. Wu, J-M. Wang, W. Cheung and P. F. Morris. 1996. Applied and Environmental Microbiology, 62: 2811-2817.
3. Khew, K. I. and G. A. Zentmeyer. 1973. Phytopathology, 63: 1511-1517.

Generally, compounds to be tested for their ability to attract zoospores through chemotaxis must have sufficient water solubility or, if of low water solubility, they must be in a suitable physical form to allow sufficient wetting and release of the test compound. Suitable physical forms could include properly emulsified samples dissolved in water-insoluble solvents or solids that have been wet or dry milled with appropriate surfactants such that the samples have adequate wetting and dispersion in water and are of a suitable size (<10 microns) to test in a capillary system.

As described by Professor Willard Wynn in the article Tropic and Taxic Responses of Pathogens to Plants in the Annual Review of Phytopathology, 1981, 19:237-55, which is expressly incorporated by reference herein, “Orientation responses by plant pathogens in host recognition can be divided into two groups:
1. Tropisms include primarily response of germ tubes and hyphae of filamentous fungi; they can also include response of nematodes when they are not freely motile and only parts of their bodies are involved.
2. Taxis includes responses of motile pathogens, or stages that are motile during a disease cycle, in soil, water, or water films on plant surfaces (fungal zoospores, bacteria, nematodes).”

As explained by Professor Wynn, fungal plant pathogens exhibit chemotropic response through positive or negative changes in the rate, direction or pattern of hyphal growth, such as by the growth of fungal hyphae or of the germ tube from a germinating spore. Chemotaxis, on the other hand, involves changes in motion. Thus, fungal plant pathogens must have a motile stage in order to exhibit a chemotactic response. The motile stage of the life cycle must be capable of self-propulsion in water. Additional information on this distinction may be found in an article published in 2002 by Brett M. Tyler in the Annual Review of Phytopathology, Volume 40, pages 137-167. Of the four major classes of fungal plant pathogens, ascomycetes, basidiomycetes, fungi imperfecti/deuteromycetes do not have any motile stages. Only the class comprised of oomycete fungi have such a stage, the zoospore, that is motile and therefore capable of chemotaxis. The zoospore attractants of the present disclosure elicit a chemotactic response by the mobile zoospores of oomycete fungi.

Prior art applications have attempted to use chemotropic rather than chemotactic attractants with copper based fungicides as a means of pathogen control. For example, PCT Patent Application No. AU91/00076 to Tate et al. seeks to solve the problem of hibernation of pathogen spores on a plant by adding substances that encourage spore germination and growth in the presence of a fungicide. The theory in the Tate application is that by providing microbial foodstuffs along with a fungicide, especially a copper based fungicide, the foodstuffs will act as metabolic stimulators that could be taken up by the spore to encourage the spore to germinate, thereby allowing the copper based fungicide to act on or destroy the spore during germination. The Tate application is directed to non-motile fungal pathogens and non-motile stages of fungal pathogens that exhibit chemotropic responses.

The present disclosure provides new methods and compositions of controlling oomycete fungal plant pathogens. The inventive composition typically comprises a composition suitable for controlling oomycete fungi capable of producing zoospores, the composition including an agriculturally effective amount of a fungicide and at least one of a zoospore attractant and a zoospore attractant derivative.

### DETAILED DESCRIPTION OF THE INVENTION

The present invention relates to compounds and the use of such compounds for increasing the efficacy of fungicides for controlling oomycete pathogen induced disease or diseases in one or more plants. The inventive methods comprise contacting a plant at risk of being diseased from an oomycete pathogen that produces zoospores with a composition comprising an effective amount of a fungicide and at least one of a zoospore attractant and a zoospore attractant derivative. Alternatively, a mixture of differing zoospore attractants and zoospore attractant derivatives may be used as well as a mixture of differing fungicides.

While not wishing to be bound by any theory it is believed that embedding, coating or surrounding a fungicide particle with a zoospore attractant or a zoospore attractant derivative to create a concentration gradient of a zoospore attractant around the fungicide particle that attracts zoospores toward the fungicide, could enhance the effectiveness of the compostion. By attracting the zoospores to the fungicide particle, the area of disease control of the fungicide is increased, possibly lowering the use rate of the fungicide. Additionally, a broader range of fungicides may be used, including fungicides that have limited redistribution on the plant surface.

While not wishing to be bound by any theory it is believed that using a zoospore attractant could enhance the effectiveness of zoospore active fungicides such as thiocarbamates such as mancozeb, maneb, zineb, thiram, propineb, or metiram; copper-based fungicides such as copper hydroxide, copper oxychloride, or Bordeaux mixture; phthalimide fungicides such as captan or folpet; aminosulbrom; strobilurins such as azoxystrobin, trifloxystrobin, picoxystrobin, kresoxim-methyl, pyraclostrobin, fluoxastrobin, and others; famoxadone; fenamidone; metalaxyl; mefenoxam; benalaxyl; cymoxanil; propamocarb; dimethomorph; flumorph; mandipropamid; iprovalicarb; benthiavalicarb-isopropyl; valiphenal; zoxamide; ethaboxam; cyazofamid; fluopicolide; fluazinam; chlorothalonil; dithianon; fosetyl-AL, phosphorous acid; tolylfluanid, aminosulfones such as 4-fluorophenyl (1S)-1-({[(1R,S)-(4-cyanophenyl)ethyl]sulfonyl}methyl)propylcarbamate or triazolopyrimidine compounds such as those shown by Formula I:

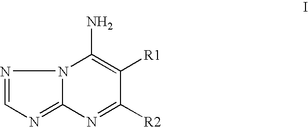

wherein R1 is ethyl, 1-octyl, 1-nonyl, or 3,5,5-trimethyl-1-hexyl and R2 is methyl, ethyl, 1-propyl, 1-octyl, trifluoromethyl, or methoxymethyl.

Useful zoospore attractants may vary depending upon the type of plant, the fungal pathogen and environmental conditions. Typical zoospore attractants may include C4-C8 aldehydes, C4-C8 carboxylic acids, C3-C8 amino acids, C4-C8 alcohols, flavones, flavanes and iso-flavones, amines, sugars, C4-C8 ketones, stilbenes, benzoins, benzoates, benzophenones, acetophenones, biphenyls, coumarins, chromanones, tetralones and anthraquinones. Zoospore attractants may also be absorbed onto or embedded into an inert substrate such as PergoPak M, corn starch, clay, latex agglomerates, or fertilizer particles.

Suitable zoospore attractant C4-C8 aldehydes may include isovaleraldehyde, 2-methylbutyraldehyde, valeraldehyde, isobutyraldehyde, butyraldehyde, 4-methylpentanal, 3,3-dimethylbutyraldehyde, 3-methylthiobutyraldehyde, 2-cyclopropylacetaldehyde, 3-methylcrotonaldehyde, 2-ethylcrotonaldehyde, crotonaldehyde, 2-methylcrotonaldehyde, furfural(2-furaldehyde), 2-thiophenecarboxaldehyde, 2-ethylbutyraldehyde, cyclopropanecarboxaldehyde, 2,3-dimethylvaleraldehyde, 2-methylvaleraldehyde, tetrahydrofuran-3-carboxaldehyde, and cyclopentanecarboxaldehyde and their derivitives such as hydrazones, acylhydrazones, oximes, nitrones, aminals, imines, enamines, bisulfite addition compounds, acetals, and condensation products with urea which can release the attractant molecules under suitable conditions.

Suitable zoospore attractant C4-C8 carboxylic acids may include isocaproic acid, isovaleric acid, valeric acid, caproic acid, cinnamic acid, and their C1-C8 ester derivatives which can release the attractant molecules under suitable conditions. Suitable zoospore attractant C3-C8 amino acids may include asparagine, L-aspartate (aspartic acid), L-glutamate, L-glutamine, L-asparagine, L-alanine, arginine, leucine, and methionine. Suitable zoospore attractant C4-C8 alcohols may include isoamyl alcohol.

Suitable zoospore attractant flavones and iso-flavones may include cochliophilin A (5-hydroxy-6,7-methylenedioxyflavone), 4′-hydroxy-5,7-dihydroxyflavone, daidzein (7,4′-dihydroxyisoflavone), genistein (5,7,4′-trihydroxyisoflavone), 5,4′-dihydroxy-3,3′-dimethoxy-6,7-methylenedioxyflavone, prunetin (5,4′-dihydroxy-7-methoxyisoflavone), N-trans-feruloyl-4-O-methyldopamine, daidzin and genistin which are carbohydrate conjugates of daidzein and genistein, respectively, biochanin A, formononetin, and isoformononetin. Suitable zoospore attractant amines may include isoamyl amine and amide derivatives thereof. Suitable zoospore attractant sugars may include naturally occurring mono- and di-saccharides such as D-glucose, D-mannose, L-fucose, maltose, D-fructose, and sucrose. Suitable zoospore attractant C4-C8 ketones may include 4-methyl-2-pentanone, 3-methyl-2-pentanone, 3,3-dimethyl-2-butanone and their derivatives such as hydrazones, acylhydrazones, oximes, nitrones, imines, enamines, bisulfite addition compounds, ketals, and condensaton products with urea which can release the attractant molecules under suitable conditions. In addition pectins, or metal ions and inorganics such as Ca, Zn, Mg, Mn, NaNO3, KNO3, and NaCl, may be added to zoospore attractants and/or zoospore attractant derivates in combination with a fungicide to improve effectiveness.

In addition to zoospore attractants, zoospore attractant derivatives may also be used for purposes such as controlled release of the attractant molecule. Zoospore attractant derivatives are chemical compounds generally made or derived from zoospore attractant molecules. Zoospore attractant derivatives may be used in combination with zoospore attractants or independently. Suitable zoospore attractant derivatives such as hydrazone derivatives of conventional zoospore attractants may be used to release a zoospore attractant when the derivative comes into contact with water on a plant surface or the area adjacent to the plant. Examples of hydrazone derivative technology are included in PCT Patent Application No. WO2006016248 and the article entitled “Controlled release of volatile aldehydes and ketones by reversible hydrazone formation—‘classical’ profragrances are getting dynamic” by Levrand et al. published in Chemical Communications (Cambridge, United Kingdom) (2006) on pages 2965-2967 (ISSN: 1359-7345). The disclosure of each of the above references is hereby expressly incorporated by reference herein.

The aforementioned zoospore attractant enhanced fungicides have been found to be particularly effective in controlling diseases caused by the pathogens Phytophthora infestans, Plasmopara viticola, Phytophthora capsici, and Pseudoperonospora cubensis. Other pathogens that may also be controlled for a variety of plants such as tomatoes, potatoes, peppers, grapes, cucurbits, lettuce, beans, sorghum, corn, citrus, turf grasses, pecans, apples, pears, hops, and crucifiers include Bremia lactucae, Phytophthora phaseoli, Phytophthora nicotiane var. parasitica, Sclerospora graminicola, Sclerophthora rayssiae, Phytophthora palmivora, Phytophthora citrophora, Sclerophthora macrospora, Sclerophthora graminicola, Phytophthora cactorum, Phytophthora syringe, Pseudoperonospora humuli, and Albugo candida.

The effective amount of the zoospore attractant to be employed with the fungicide often depends upon, for example, the type of plants, the stage of growth of the plant, severity of environmental conditions, the fungal pathogen and application conditions. Typically, a plant in need of fungal protection, control or elimination is contacted with an amount of zoospore attractant or zoospore attractant derivative from about 1 to about 5000 ppm, preferably from about 10 to about 1000 ppm of an attractant or zoospore attractant derivative The contacting may be in any effective manner. For example, any exposed part of the plant, e.g., leaves or stems may be sprayed with the attractant or attractant derivative in mixture with effective rates of a fungicide The attractant or attractant derivative may be formulated by itself in an agriculturally suitable carrier and comprise 1 to 95% by weight of the formulation. One or more attractants or attractant derivatives may be co-formulated with one or more fungicides as a liquid or a solid wherein the attractant, attractant derivative, or mixture of one or more attractants or attractant derivatives comprises 1 to 50% of the formulation.

The aforementioned zoospore attractant enhanced fungicides may be applied to the plant foliage or the soil or area adjacent to the plant. Additionally, the zoospore attractant enhanced fungicides may be mixed with or applied with any combination of herbicides, insecticides, bacteriocides, nematocides, miticides, biocides, termiticides, rodenticides, molluscides, arthropodicides, fertilizers, growth regulators, and phermones.

It is envisioned that substances that induce encystment of zoospores, such as pectin, a metal ion, and an inorganic compound or inorganic salt compound selected from the group consisting of Ca, Zn, Mg, Mn, NaNO3, KNO3, and NaCl, may be added to compositions containing a fungicide and a zoospore attractant or zoospore attractant derivative to further improve disease control.

### EXAMPLES

The following examples were carried out on greenhouse and growth chamber experiments on cucumber plants. The cucumber plants were grown from seed in soil-free medium mix (Metro-Mix 360®) and maintained in a glasshouse with supplementary light sources to provide a 16 hour photoperiod at 24-29° C. until the plants had produced 1-2 true leaves. Plants were then trimmed to 1 true leaf, approximately 8 cm across by removing any additional leaves.

Referring below to Table 1, Dithane M45 and Dithane OS are standard commercial formulations. Isovaleraldehyde loaded onto PergoPak was prepared using the following procedure: a mixture of 1.35 g of PergoPak M (polyurea), 0.15 g of isovaleraldehyde and 8 mL of ether was stirred at room temperature for 10 min. The mixture was then concentrated by rotatory evaporation at room temperature under a slight vacuum to provide a solid that was air dried for an hour at room temperature and then bottled. All treatments were prepared by adding the appropriate amount of each treatment to distilled water to give the desired concentration of active ingredient. Dithane® M45 suspensions were initially prepared via serial dilution. Mancozeb/isovaleraldehyde solutions were prepared by adding a prepared isovaleraldehyde solution to a prepared mancozeb suspension. All solutions were vortexed and sonicated prior to treatment application to ensure that they were homogenous.

TABLE 1
Chemical formulations used in experiments on Pseudoperonospora
cubensis.

| Formulation | Composition |
|---|---|
| Dithane M45 | 80% (800 g/kg) wettable powder formulation of |
| | mancozeb fungicide |
| Dithane OS | 60% (600 g/kg) oil flowable formulation of mancozeb |
| | fungicide |
| Zoxium | 80% (800 g/kg) wettable powder formulation of |
| | zoxamide fungicide |
| Bravo | 50% (500 g/kg) sprayable concentrate formulation of |
| | chlorothalonil |
| Isovaleraldehyde | 100% isovaleraldehyde |
| Isovaleraldehyde | Approximately 10% loading of isovaleraldehyde on |
| plus PergoPak | inert substrate PergoPak M |
| M⁽¹⁾ | |
| Isovaleraldehyde | 100% isovaleraldehyde bisulfite adduct, sodium |
| bisulfite adduct, | |
| sodium | |

⁽¹⁾PergoPak M is a urea-formaldehyde polymer used as a solid carrier for liquids.

A sporangial suspension of Pseudoperonospora cubensis was made by collecting leaves with freshly sporulating lesions and washing them in distilled water, which was made up of equal volumes of chilled (4° C.) and tap distilled water (21° C.). The suspension was then left on the lab bench for 2 hours to allow the release of zoospores from the sporangia. After 2 hours the suspension was filtered through filter paper (“Whatman”, 12.5 cm, grade 113V) to remove any remaining sporangia and mycelial fragments. The zoospore concentration was determined and then adjusted to the desired concentration with distilled water.

For each example described below, an area 5 cm wide by 1 cm deep was initially marked on each cucumber leaf by placing a mark in each corner of the area. This was repeated on four separate plants to give four replicates for each treatment. Ten 15 microlitre drops were then applied to each leaf in two 5 drop bands (1 cm between each drop) and allowed to dry overnight. Subsequently a zoospore suspension of Pseudoperonospora cubensis (30,000 zoospores/mL) was sprayed with a hand-atomiser to the entire leaf until run-off. Plants were placed in a dew room (22° C. and 99% RH) for 24 hours then maintained in a growth room with supplementary light sources to provide a 14 hour photoperiod at 18° C. and 70% RH until disease assessment.

Assessment of the effectiveness of the treatment was done by visual infection within the banded area. The banded area was evaluated on a percentage scale (with 0% representing no infection and 100% representing infection of the entire area) after 5-7 days.

### Example 1

In the first experiment Dithane 60 OS alone at 100, 50, and 10 ppm was compared with Dithane 60 OS at equivalent rates with the addition isovaleraldehyde sorbed to PergoPak M. The results of the experiment are shown in Table 2. Addition of isovaleraldehyde to mancozeb resulted in reduction of infection compared to mancozeb without isovaleraldehyde. No plant injury was observed from any of the treatments.

TABLE 2
Percent infection of Pseudoperonospora cubensis on cucumbers
following treatment with mancozeb formulated as Dithane 60 OS alone
and with the addition of isovaleraldehyde 5 days after application.

| | |
|---|---|
| | Mancozeb |
| Isovaleraldehyde | rate (ppm) |

| rate (ppm) | 0 | 10 | 50 | 100 |
|---|---|---|---|---|
| 0 | 40 | 31 | 25 | 10 |
| 50 | 41 | 26 | 11 | 5 |
| 100 | 34 | 16 | 1 | 5 |
| 500 | 44 | 9 | 3 | 3 |

### Example 2

In the second experiment Dithane M45 alone at 100, 50, and 10 ppm was compared with Dithane M45 at equivalent rates with the addition of pure isovaleraldehyde at 50 and 100 ppm. The results of the experiment are shown in Table 3. Addition of isovaleraldehyde to mancozeb reduced the level of infection compared to mancozeb alone No plant injury was observed from any of the treatments.

TABLE 3
Percent infection of Pseudoperonospora cubensis on cucumbers
following treatment with mancozeb formulated as Dithane M45 alone
and with the addition of isovaleraldehyde 6 days after application.

| | |
|---|---|
| | Mancozeb |
| Isovaleraldehyde | rate (ppm) |

| rate (ppm) | 0 | 10 | 50 | 100 |
|---|---|---|---|---|
| 0 | 54 | 31 | 21 | 16 |
| 50 | 51 | 25 | 10 | 3 |
| 100 | 44 | 5 | 8 | 8 |

### Example 3

In the third experiment Dithane M45 alone at 100, 50, and 10 ppm was compared with Dithane M45 at equivalent rates with the addition of isovaleraldehyde and the bisulfite adduct of isovaleraldehyde at 100 ppm.

Zoxamide alone at 25, 5, and 1 ppm and chlorothalonil alone at 100, 20 and 5 ppm alone were compared with equivalent rates of zoxamide and chlorothalonil with the addition of isovaleraldehyde at 100 ppm. The results of the experiment are shown in Table 4. Addition of isovaleraldehyde to mancozeb, zoxamide and chlorothalonil and the addition of isovaleraldehyde bisulfite adduct, sodium to mancozeb improved disease control compared to mancozeb, zoxamide and chlorothalonil alone. No plant injury was observed from any of the treatment.

TABLE 4
Percent infection of Pseudoperonospora cubensis on cucumbers
following treatment with mancozeb formulated as mancozeb,
zoxamide, and chlorothalonil alone and with the addition of
isovaleraldehyde 7 days after application.

| | |
|---|---|
| | Mancozeb |
| Isovaleraldehyde | rate (ppm) |

| rate (ppm) | 0 | 10 | 50 | 100 |
|---|---|---|---|---|
| 0 | 49 | 30 | 11 | 6 |
| 100 | 41 | 8 | 3 | 0 |
| 100¹ | 45 | 6 | 3 | 1 |

| | |
|---|---|
| | Zoxamide |
| Isovaleraldehyde | rate (ppm) |

| rate (ppm) | 0 | 1 | 5 | 25 |
|---|---|---|---|---|
| 0 | 49 | 28 | 16 | 16 |
| 100 | 41 | 17 | 6 | 5 |

| | |
|---|---|
| | Chlorothalonil |
| Isovaleraldehyde | rate (ppm) |

| rate (ppm) | 0 | 5 | 20 | 100 |
|---|---|---|---|---|
| 0 | 49 | 24 | 9 | 0 |
| 100 | 41 | 12 | 7 | 2 |

¹Isovaleraldehyde bisulfite adduct, sodium

### Example 4

Two zoospore attractants derivatives, Compounds A and Compound B, shown in Table 5, were formulated as 10% sprayable suspension concentrates, as described below, and tested in a field trial both alone and in combination with Dithane on Late Blight of Potato, a disease caused by the oomycete pathogen, Phytophthora infestans. Treatments were diluted in water and applied at a spray volume of 400 liters/ha. Sprays were applied six times at approximately weekly intervals. The level of disease in the crop was assessed by making visual determinations of the percent of the foliage infested by the fungus. When rated 8 days after the sixth application, Compound A or Compound B combined with Dithane resulted in 20 and 9% disease respectively. The results of the tests are shown below in Table 6. Both Compound A and Compound B were observed to significantly improve disease control compared to Dithane alone.

TABLE 5
Identification of Compounds A and B

| | |
|---|---|
| Compound A | 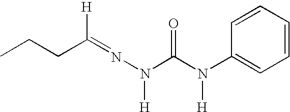 |
| Compound B (condensation product of urea and isovalderaldehyde) | 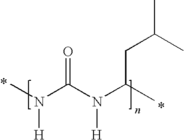 |

Compound A was prepared by heating a mixture of 4-phenylsemicarbazide and 1.1 equivalents of isovaleraldehyde at reflux in ethanol solvent for 3-6 hours. The mixture was then concentrated to approximately one half volume by evaporation under reduced pressure and then allowed to cool to room temperature over many hours. The crystalline solid obtained was washed with ethanol and was then dried to constant weight. The isolated solid was characterized by proton NMR and by CHN elemental analysis. This material was ball-milled in water with a suitable surfactant to provide a 10% aqueous suspension.

Compound B was prepared by beginning with a a mixture of isovaleraldehyde, water and a catalytic amount of 85% phosphoric acid that was mechanically stirred, heated to approximately 40° C. and treated quickly with a solution of 2 equivalents of urea dissolved in water. The resulting solution exothermed to approximately 60° C. as a heavy, white solid formed. The very viscous mixture was stirred for one hour at ambient temperature and the solid present was collected by filtration, washed with water and vacuum oven dried to constant weight. This material was ball-milled in water with a suitable surfactant to provide a 10% aqueous suspension.

TABLE 6
Infection of Phytophthora infestans on potatoes following
treatment with Dithane alone and with the addition of
Compound A or Compound B.

| Treatment | Rate | % Disease |
|---|---|---|
| Untreated check | 0 | 98 |
| Dithane | 600 g ai/ha | 31 |
| Dithane plus Compound A | 600 g ai/ha plus 300 ppm | 20 |
| Dithane plus Compound B | 600 g ai/ha plus 300 ppm | 9 |
| Compound A | 300 ppm | 98 |
| Compound B | 300 ppm | 98 |

### Examples 5a-d

Examples 5a through 5d were conducted in growth chambers on cucumber plants. Cucumbers (Cucumis sativus cv Bush Pickle Hybrid #901261) were grown from seed in 5 cm by 5 cm pots containing MetroMix™ growth medium (Scotts, Marysville, Ohio) and maintained in a glasshouse with supplementary light sources to provide a 14 hour photoperiod at 24-29° C. until the plants were in the 2-3 true leaf stage of growth and the oldest leaf was fully expanded.

For examples 5a through 5d, described below, samples of mancozeb formulated as Dithane DG NT were dissolved in water to form a ½×dilution series. Mancozeb rates were 400, 200, 100 and 50 ppm. Samples of various aldehydes, amino acids, carboxylic acids, amines and alcohols were dissolved in acetone and then mixed with aqueous solutions of mancozeb. Attractant rates in the dilute solutions were 100, 200, 500 or 1000 ppm, depending on the experiment.

Mixtures of attractant or attractant derivative plus mancozeb or mancozeb alone were applied to cucumber as a row of 5 or 7.5 ul droplets using a multi-channel pipetting device. Five droplets spaced 1 cm apart were placed along the mid-rib of the expanded cucumber leaf with the first droplet being positioned at least 1-cm from the leaf apex. Each treatment was replicated three or four times, depending on the experiment. Two to three hours after applying the treatments when droplets had dried, plants were inoculated with a suspension of sporangia of a Pseudoperonospora cubensis (PSPECU) and incubated as described in the methods for sprayed tests. When symptoms were well developed in untreated check plants, the experiment was assessed visually using a template 2 cm wide and 7 cm long with the long axis centered on the mid-rib of the treated leaf. The percent of the area within the template exhibiting disease symptoms was assessed.

Reduction in percent disease was calculated by subtracting percent disease on plants receiving a mixture of mancozeb plus the specified test substance from percent disease on plants receiving mancozeb alone. The results for examples 5a-5d are shown below in Tables 7-10; the reduction in percent disease was indicated as follows:

x 0-20% reduction in percent disease

xx 21-35% reduction in percent disease

xxx 36-50% reduction in percent disease

xxxx >50% reduction in percent disease

TABLE 7
The effect of various aldehydes, amino acids,
carboxylic acids, amines and alcohols at 200 and
1000 ppm on the effectiveness of mancozeb at 50 ppm
on PSPECU.

| | |
|---|---|
| | % disease at |
| Reduction | 1000 ppm of |
| in % Disease | substance |

| Substance | 200 ppm | 1000 ppm | alone |
|---|---|---|---|
| Isovaleraldehyde | xxxx | xxx | 100 |
| Isovaleric acid | xx | xx | 100 |
| Isocaproic acid | xxx | xxx | 100 |
| Isoamyl alcohol | xx | x | 100 |
| Isobutanol | x | xxxx | 100 |
| Isoamyl amine | xxx | xxx | 100 |
| Glutamic acid | xx | x | 100 |
| Aspartic acid | xx | xx | 100 |

Percent disease in untreated check plants: 100%

TABLE 8
The effect of various aldehydes, amino
acids, carboxylic acids and alcohols at
500 ppm on the effectiveness of
mancozeb at 200 ppm on PSPECU

| | | % disease at |
|---|---|---|
| | | 500 ppm of |
| | Reduction | substance |
| Substance | in % Disease | alone |
| Isovaleraldehyde | xx | 93 |
| Isocaproic acid | x | 88 |
| Isobutanol | x | 95 |
| Glutamic acid | x | 90 |
| 3-methyl-2- | x | 81 |
| butenaldehyde | | |
| Cyclopropylacetaldehyde | x | 90 |
| 3,3- | x | 75 |
| dimethylbutyraldehyde | | |
| 2-methylbutyraldehyde | x | 74 |
| Valeraldehyde | x | 94 |

Percent disease in untreated check plants: 91%

TABLE 9
The effect of various aldehydes
at 100 ppm on the effectiveness
of mancozeb at
200 ppm on PSPECU.

| | | % |
|---|---|---|
| | | disease at |
| | | 100 ppm |
| | | of |
| | | substance |
| Substance | Reduction in % Disease | alone |
| Isovaleraldehyde | xx | 86 |
| Isobutyraldehyde | x | 97 |
| 2-methylbutyraldehyde | x | 98 |
| 3,3- | x | 96 |
| dimethylbutyraldehyde | | |
| 3-methyl-2- | x | 100 |
| butenaldehyde | | |
| Valeraldehyde | x | 93 |
| Cyclopropylacetaldehyde | x | 85 |
| 2-ethylbutyraldehyde | x | 65 |

Percent disease in untreated check plants: 92%

TABLE 10
The effect of various aldehydes
at 100 ppm on the effectiveness
of mancozeb at
200 ppm on PSPECU.

| | | % |
|---|---|---|
| | | disease at |
| | | 100 ppm |
| | | of |
| | | substance |
| Substance | Reduction in % Disease | alone |
| 4-methyl-2-pentanone | x | 93 |
| 3-methyl-2-pentanone | x | 100 |

Percent disease in untreated check plants: 100%

### Experimental Methods used in Examples 6-9

Examples 6-9 were carried out on grapes, tomatoes or cucumbers. Grapes (Vitis vinifera cv Carignane), tomatoes (Solanum esculentum cv Outdoor Girl), and cucumbers (Cucumis sativus cv Bush Pickle Hybrid #901261) were grown from seed in 5 cm by 5 cm pots containing MetroMix™ growth medium (Scotts, Marysville, Ohio). Plants were raised in greenhouses on a 14 hour photoperiod and maintained at 20-26° C. Healthy plant growth was maintained through regular application of dilute liquid fertilizer solution containing a complete range of nutrients. When plants were in the 2-4 true leaf stage of growth, plants with uniform growth were selected for spray application and trimmed. Grapes were trimmed to have two true leaves; cucumbers were trimmed to have one fully expanded true leaf.

Attractants, attractant derivatives and fungicides were formulated in water. Fungicides were formulated as ¼× dilution series. Rates in the final spray solution ranged from 25 ppm to 0.24 ppm rates. Four sequential rates were selected from this dilution series based on the potency of each fungicide on each of the diseases.

Substances tested in examples 7a-7e were milled into particles with a size of less than 10 microns and then formulated as 10% sprayable suspension concentrates. In examples 8a-8e and example 9, except as noted below, technical samples of fungicides were employed. They were first dissolved in acetone and then dissolved in water. Mancozeb was formulated as Dithane DG NT; zoxamide was formulated as a 80% wettable powder. These fungicides were suspended directly into water. Attractant derivative formulations I and II were formulated as 10% sprayable suspension concentrates and suspended directly in the spray mixture. The compositions of zoospore attractant derivative formulation I and II are shown below in Table 23.

Attractant and or attractant derivative rates in the final spray solution were 100 or 500 ppm, depending on the test. The dilute spray solutions were applied using an automated high volume rotary sprayer fitted with two 6128-¼ JAUPM spray nozzles (Spraying Systems, Wheaton, Ill.) pressurized at 20 psi and configured to provide thorough coverage of both leaf surfaces. Each treatment was replicated 3 or 4 times. Sprayed plants were randomized after spray application.

Plants were inoculated 18-24 hours after formulations were applied. Inoculum of Phytophthora infestans (PHYTIN) was prepared from cultures grown in the dark on solid rye seed agar. When abundant sporangia were present, deionized water was added to the plates and then brushed lightly to dislodge sporangia. Inoculum of Plasmopara viticola (PLASVI) was produced by placing infected grape plants in a dew chamber overnight to promote sporulation. Leaves with abundant sporangia were placed in deionized water and brushed lightly to dislodge sporangia. Similarly, inoculum of Pseudoperonospora cubensis was produced by placing infected cucumber plants in a dew chamber overnight to promote sporulation. Leaves with abundant sporangia were placed in deionized water and brushed lightly to dislodge sporangia.

Sporangium concentration of each pathogen was adjusted to 50,000 to 80,000 sporangia per ml. Plants were inoculated by applying a fine mist with a low pressure (5 psi) compressed air sprayer at a volume of approximately 200 ml per 80 pots of grapes, tomatoes, or cucumbers. Plants were incubated for 24 hours in a dew chamber maintained at about 16-22° C., depending on the pathogen and the test. Tomatoes and cucumbers were then transferred to well-lighted growth chambers maintained at 20° C. for subsequent disease development. Grapes were transferred to a greenhouse on a 14 hour photoperiod and maintained at 24-26° C. for symptom development. Visual assessments of the level of disease on tomatoes and cucumbers were made 4-7 days after inoculation when the level of disease in untreated but inoculated check plants reached 75-95% disease. When symptoms were clearly visible on grape leaves, they were moved into a dew chamber to allow sporulation. Visual assessments of the level of disease were then made based on the percent of the lower leaf surface covered by sporulating lesions. Reduction in percent disease was calculated by subtracting percent disease on plants receiving a mixture of mancozeb plus the specified test substance from percent disease on plants receiving mancozeb alone. The results for examples 5a-5d are shown below in Tables 7-10, the reduction in percent disease was indicated as follows:

x 0-20% reduction in percent disease

xx 21-35% reduction in percent disease

xxx 36-50% reduction in percent disease

xxxx >50% reduction in percent disease

NT not tested

- antagonism

### Example 6

Various substances demonstrating responses in Examples 5a-5d were tested as foliar sprays at the rate of 500 ppm in mixture with mancozeb formulated as Dithane DGNT. The substances tested in example 6 were dissolved in acetone and then diluted in water. Treated plants were inoculated 2 to 3 hours after the plants were treated. The results are shown below in Table 11.

TABLE 11
The effect of various aldehydes, amino acids,
carboxylic acids and alcohols at 500 ppm
on the effectiveness of mancozeb
applied at 6.25 ppm and
25 ppm on PLASVI and PHYTIN.

| | Reduction in | | % disease at 500 ppm | |
|---|---|---|---|---|
| | percent disease | | of substance | |
| | PLASVI | PHYTIN | alone | |
| Substance | 6.25 | 25 | PLASVI | PHYTIN |
| Isovaleraldehyde | xxx | xxx | 93 | 77 |
| Isocaproic acid | xxx | xxx | 93 | 95 |
| Isobutanol | xxxx | xxx | 78 | 95 |
| Glutamic Acid | xxx | xx | 93 | 95 |
| 3-Methyl-2- | xxx | x | 95 | 95 |
| butenaldehyde | | | | |
| Cyclopropylacetaldehyde | xx | x | 95 | 95 |
| 3,3- | x | x | 87 | 95 |
| dimethylbutyraldehyde | | | | |
| 2-methylbutyraldehyde | x | x | 95 | 95 |
| Valeraldehyde | x | x | 95 | 95 |

| | | |
|---|---|---|
| Level of disease in untreated | 95 | 95 |
| check plants | | |

### Examples 7a-e

Various derivatives of isovaleraldehyde were tested in combination with mancozeb. Substances tested in examples 7a-e were milled into particles with a size of less than 10 micron and then formulated as 10% sprayable suspension concentrates. Substances tested in example 7e were solubilized in acetone. Mancozeb was formulated as Dithane DG NT. Compounds were diluted in water, sprayed and then inoculated 18-24 hours later as described above. Identification of the compounds used in the following examples are shown in Table 12. The results for examples 7a-e are shown in Tables 13-17.

TABLE 12
Identification of Compounds C-AA

| | |
|---|---|
| Compound C | 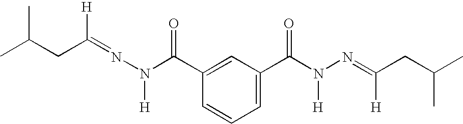 |
| Compound D | 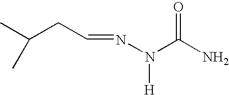 |
| Compound E | 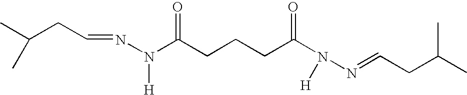 |
| Compound F | 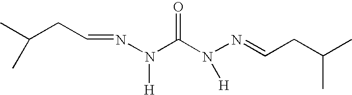 |
| Compound G | 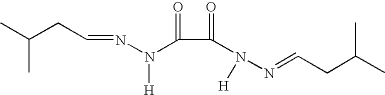 |
| Compound H | 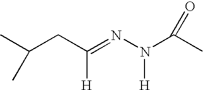 |
| Compound I | 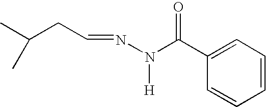 |
| Compound J | 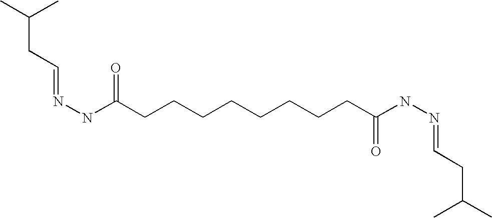 |
| Compound K | 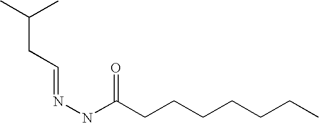 |
| Compound L | 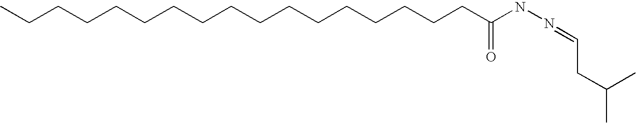 |
| Compound M | 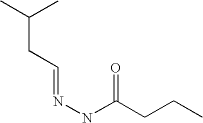 |
| Compound N | 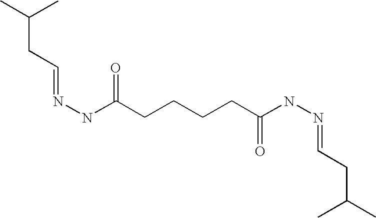 |
| Compound O | 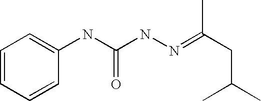 |
| Compound P | 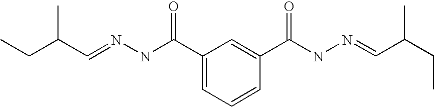 |
| Compound Q (condensation product of urea and 2- methylbutyraldehyde) | 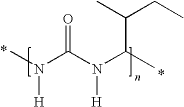 |
| Compound R (condensation product of urea and 3,3- dimethylbutyraldehyde) | 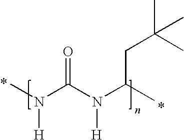 |
| Compound S | 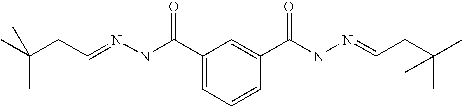 |
| Compound T | 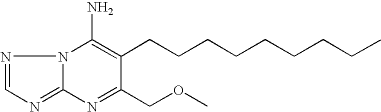 |
| Compound U | 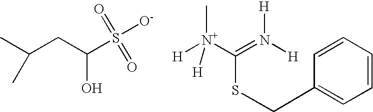 |
| Compound V | 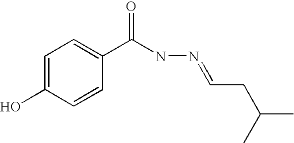 |
| Compound W | 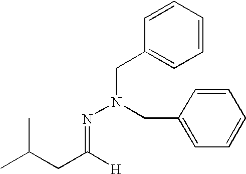 |
| Compound X | 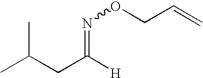 |
| Compound Y | 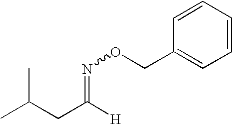 |
| Compound Z | 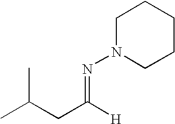 |
| Compound AA | 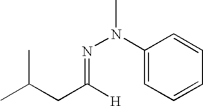 |

TABLE 13
The effect of various aldehyde derivatives at
100 ppm on the effectiveness of mancozeb
on PLASVI.

| Compound | Reduction in percent disease |
|---|---|
| C | xx |
| A | xx |
| B | xx |
| D | x |
| E | xx |
| F | x |
| G | xx |
| H | xx |
| Level of disease in | 95 |
| untreated check | |

TABLE 14
The effect of various aldehyde derivatives at
100 ppm on the effectiveness of mancozeb
on PSPECU

| Compound | Reduction in percent disease |
|---|---|
| C | xxx |
| A | xx |
| B | x |
| D | xx |
| E | xxx |
| F | xx |
| G | xxx |
| H | xx |
| I | xx |
| J | xx |
| K | xx |
| L | xx |
| M | xxx |
| N | xx |
| Level of disease in | 95 |
| untreated check | |

TABLE 15
The effect of various aldehyde derivatives at
100 ppm on the effectiveness of mancozeb
on PLASVI

| Compound | Reduction in percent disease |
|---|---|
| C | xx |
| B | xx |
| J | x |
| K | xx |
| L | xxx |
| M | xx |
| N | x |
| Level of disease in | 95 |
| untreated check | |

TABLE 16
The effect of various aldehyde
derivatives at 500 ppm on the
effectiveness of mancozeb.

| | Reduction in percent disease | | |
|---|---|---|---|
| Compound/Disease | PLASVI | PHYTIN | PSPECU |
| O | x | xx | xx |
| P | x | x | x |
| Q | x | x | x |
| R | x | xx | x |
| S | x | xx | x |
| Level of disease in | 92 | 95 | 95 |
| untreated check | | | |

TABLE 17
The effect of various
aldehyde derivatives at
100 ppm on the
effectiveness of mancozeb.

Reduction in percent
disease

| Derivative/Disease | PLASVI | PHYTIN |
|---|---|---|
| U | X | xx |
| V | X | xx |
| W | X | xx |
| X | X | xx |
| Y | NT | x |
| Z | X | xx |
| AA | X | x |
| Level of disease in | 95 | 95 |
| untreated check | | |

### Examples 8a-e

Various fungicides known to have fungicidal activity on oomycete diseases were tested in combination with Formulations I and II, which were formulated as 10% sprayable concentrates. Technical samples of fungicides were used except for mancozeb, which was formulated as Dithane DG NT, mefenoxam, which was formulated as Ridomil Gold, and zoxamide, which was formulated as a 80% wettable powder. Technical samples were first dissolved in acetone and then diluted in water. Pre-formulated fungicides were suspended directly in water. Fungicides were formulated as ¼× dilution series. Rates in the final spray solution ranged from 25 ppm to 0.24 ppm rates. Four sequential rates were selected from this dilution series based on the potency of each fungicide on each of the diseases. The attractant derivative Formulations I and II were tested at 100 ppm. The results for examples 8a-e are shown in Tables 18-22.

TABLE 18
The effect of Formulation I at
100 ppm on the effectiveness of
various fungicides

| | Reduction in percent disease | | |
|---|---|---|---|
| Fungicide | PLASVI | PSPECU | PHYTIN |
| Azoxystrobin | x | x | xx |
| Cymoxanil | x | x | xx |
| Mancozeb | xx | x | x |
| Kresoxim-methyl | — | x | x |
| Picoxystrobin | xxx | — | x |
| Pyraclostrobin | NT | x | x |
| Propamocarb | x | x | xx |
| Mefenoxam | — | NT | xxxx |
| Percent disease in | 95 | 95 | 87 |
| untreated check | | | |
| plants | | | |

TABLE 19
The effect of Formulation I at
100 ppm on the effectiveness of
various fungicides

| | Reduction in percent disease | | |
|---|---|---|---|
| Fungicide | PLASVI | PSPECU | PHYTIN |
| Benthiavalicarb | x | xx | x |
| Cyazofamid | x | NT | x |
| Dimethomorph | xx | x | x |
| Dimoxystrobin | x | x | x |
| Mancozeb | xx | xx | xxx |
| Ethaboxam | x | — | x |
| Famoxadone | x | x | xx |
| Fluazinam | xxx | NT | xxx |
| Iprovalicarb | xx | x | x |
| Mandipropamid | xx | x | x |
| Trifloxystrobin | x | — | x |
| Percent disease in | 95 | 73 | 95 |
| untreated check | | | |
| plants | | | |

TABLE 20
The effect of Formulation I at
100 ppm on the effectiveness of
various fungicides

| Fungicide | PLASVI | PSPECU | PHYTIN |
|---|---|---|---|
| Mancozeb | xx | xx | xx |
| Zoxamide | — | x | xx |
| Metalaxyl | x | x | xx |
| Fluopicolide | — | x | xx |
| Amisulbrom | x | NT | x |
| Copper oxychloride | x | x | x |
| Azoxystrobin | — | x | xxx |
| Mefenoxam | x | — | xx |
| Percent disease in | 95 | 95 | 95 |
| untreated check | | | |
| plants | | | |

TABLE 21
The effect of Formulation I and II
at 100 ppm on the effectiveness
of various fungicides

Reduction in percent disease

| Treatment | Disease | Formul. II | Formul. I |
|---|---|---|---|
| Compound T | PLASVI | x | x |
| Compound T | PLASVI | x | x |
| Cyazofamid | PLASVI | x | x |
| Ethaboxam | PLASVI | x | x |
| Amisulbrom | PLASVI | xx | xxx |
| Compound T | PHYTIN | x | x |
| Cyazofamid | PHYTIN | xxx | xx |
| Amisulbrom | PHYTIN | x | x |
| Compound T | PSPECU | x | x |
| Compound T | PSPECU | x | x |
| Cyazofamid | PSPECU | x | — |
| Ethaboxam | PSPECU | x | — |
| Amisulbrom | PSPECU | x | x |

Percent disease in untreated PLASVI check plants: 95%
Percent disease in untreated PHYTIN check plants: 85%
Percent disease in untreated PSPECU check plants: 90%

TABLE 22
The effect of Formulation I and
Formulation II at 100 ppm of
attractant derivative on the
effectiveness of various fungicides

Reduction in percent disease

| | | Formul. | |
|---|---|---|---|
| Treatment | Disease | II | Formul. I |
| Chlorothalonil | PLASVI | NT | x |
| Fluopicolide | PLASVI | x | NT |
| Mefenoxam | PLASVI | xx | NT |
| Folpet | PHYTIN | NT | x |
| Chlorothalonil | PHYTIN | NT | x |
| Picoxystrobin | PHYTIN | x | NT |
| Mefenoxam | PHYTIN | xx | NT |
| Folpet | PSPECU | NT | x |
| Chlorothalonil | PSPECU | NT | x |
| Kresoxim-methyl | PSPECU | x | NT |
| Picoxystrobin | PSPECU | x | NT |
| Mefenoxam | PSPECU | x | NT |

Percent disease in untreated PLASVI check plants: 95%
Percent disease in untreated PHYTIN check plants: 95%
Percent disease in untreated PSPECU check plants: 95%

### Example 9

Mixtures of two fungicides were tested in combination with the attractant derivative Formulations I and II. Technical samples of fluazinam and dimethomorph were first dissolved in acetone. Mancozeb was formulated as Dithane DG NT. Fungicides and attractant derivatives were suspended in water, sprayed and then inoculated as described in the general methods. The results of Example 9 are shown below in Table 23.

TABLE 23
The effect of Formulation I and II at
100 ppm on the effectiveness of
fungicide mixtures

| | Percent disease | |
|---|---|---|
| | 3.1 ppm | 1.6 ppm |
| Test mixture | mancozeb | mancozeb |
| Mancozeb | 79 | 71 |
| Mancozeb + Fluazinam | 44 | 63 |
| Mancozeb + Fluazinam + Formul. I | 41 | 25 |
| Mancozeb + Fluazinam + Formul. II | 33 | 43 |
| Mancozeb + Dimethomorph | 34 | 63 |
| Mancozeb + Dimethomorph + Formul. II | 3 | 33 |
| Mancozeb + Dimethomorph + Formul. I | 1 | 5 |

Ratio of mancozeb to fluazinam was 1:1
Ratio of mancozeb to dimethomorph was 2:1
Level of disease in untreated check plants was 95%

TABLE 24
Compositions of Formulations I and II

| | | Dry weight |
|---|---|---|
| | | basis (except |
| Formulation No. | Ingredient | water) |
| I | Pluronic P-105 | 3.00% |
| | Morwet D-425 | 2.00% |
| | Compound C (milled) | 10.00% |
| | Antifoam B | 1.00% |
| | Proxel GXL | 0.10% |
| | Water | 83.90% |
| II | Calcium | 5.00% |
| | lignosulfonate | |
| | Compound B (milled) | 10.00% |
| | Antifoam B | 1.00% |
| | Proxel GXL | 0.10% |
| | Water | 83.90% |

While the invention has been described with respect to a limited number of embodiments, the specific features of one embodiment should not be attributed to other embodiments of the invention. No single embodiment is representative of all aspects of the invention. In some embodiments, the compositions or methods may include numerous compounds or steps not mentioned herein. In other embodiments, the compositions or methods do not include, or are substantially free of, any compounds or steps not enumerated herein. Variations and modifications from the described embodiments exist. Finally, any number disclosed herein should be construed to mean approximate, regardless of whether the word “about” or “approximately” is used in describing the number. The appended embodiments and claims intend to cover all those modifications and variations as falling within the scope of the invention.

1. A composition suitable for controlling oomycete fungi capable of producing zoospores, the composition including:
an agriculturally effective amount of a fungicide; and
at least one of a zoospore attractant and a zoospore attractant derivative.

2. The composition of claim 1, wherein the zoospore attractant is selected from a group consisting of C4-C12 aldehydes, C4-C12 ketones, C4-C12 amino acids, C4-C12 carboxylic acids, C4-C12 alcohols, C4-C12 amines, flavones, isoflavones, stilbenes, benzoins, benzoates, benzophenones, acetophenones, biphenyls, coumarins, chromanones, tetralones and anthraquinones and mixtures thereof.

3. The composition of claim 2, wherein the zoospore attractant is selected from a group consisting of C4-C12 aldehydes, C4-C12 ketones, C4-C12 amino acids, C4-C12 carboxylic acids, C4-C12 alcohols, C4-C12 amines.

4. The composition of claim 3, wherein the zoospore attractant contains from 4 to 8 carbon atoms.

5. The composition of claim 4, wherein the zoospore attractant contains an iso-propyl structural fragment.

6. The composition of claim 2, wherein the zoospore attractant derivative is derived from the zoospore attractant.

7. The composition of claim 3, wherein the zoospore attractant is a C4-C8 ketone selected from the group consisting of 4-methyl-2-pentanone, 3-methyl-2-pentanone, 3,3-dimethyl-2-butanone.

8. The composition of claim 7, wherein the zoospore attractant derivative is a C4-C8 ketone derivative selected from the group consisting of hydrazones, acylhydrazones, oximes, nitrones, imines, enamines, a bisulfite addition compound, and ketals.

9. The composition of claim 1, wherein the zoospore attractant derivative is derived from one of an aldehyde and a ketone.

10. The composition of claim 1, wherein the fungicide is selected from the group consisting of mancozeb, maneb, zineb, thiram, propineb, metiram, copper hydroxide, copper oxychloride, Bordeaux mixture, captan, folpet, amisulbrom, azoxystrobin, trifloxystrobin, picoxystrobin, kresoxim-methyl, famoxadone, fenamidone, metalaxyl, mefenoxam, benalaxyl, cymoxanil, propamocarb, dimethomorph, flumorph, mandipropamid, iprovalicarb, benthiavalicarb-isopropyl, valiphenal, zoxamide, ethaboxam, cyazofamid, fluopicolide, fluazinam, chlorothalonil, dithianon, tolylfluanid, 4-fluorophenyl (1S)-1-({[(1R,S)-(4-cyanophenyl)ethyl]sulfonyl}methyl)propylcarbamate and compounds of Formula 1: 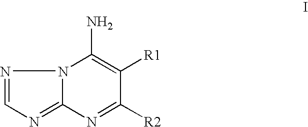
wherein
R1 is ethyl, 1-octyl, 1-nonyl, or 3,5,5-trimethyl-1-hexyl; and
R2 is methyl, ethyl, 1-propyl, 1-octyl, trifluoromethyl, and methoxymethyl.

11. The composition of claim 1, wherein the composition includes a mixture of the zoospore attractant and the zoospore attractant derivative.

12. The composition of claim 1, wherein the composition includes a mixture of zoospore attractants.

13. The composition of claim 1, wherein the composition includes a mixture of zoospore attractant derivatives.

14. The composition of claim 1, further comprising a mixture of fungicides.

15. The composition of claim 1, wherein the fungicide is a non-copper based fungicide.

16. The composition of claim 1, wherein the fungicide is adapted to control diseases caused by oomycete fungal pathogens selected from the group consisting of Phytophthora infestans, Plasmopara viticola, Phytophthora capsici, Pseudoperonospora cubensis Bremia lactucae, Phytophthora phaseoli, Phytophthora nicotiane var. parasitica, Sclerospora graminicola, Sclerophthora rayssiae, Phytophthora palmivora, Phytophthora citrophora, Sclerophthora macrospora, Sclerophthora graminicola, Phytophthora cactorum, Phytophthora syringe, Pseudoperonospora humuli, and Albugo candida.

17. A method of controlling plant diseases caused by oomycete fungal pathogens including the steps of:
applying at least one of a formulation and a mixture including the composition of claim 1 to at least one of the plant, the area adjacent to the plant, plant foliage, blossoms, stems, fruits, soil, seeds, germinating seeds, roots, liquid and solid growth media, and hydroponic growth solutions.

18. The composition of claim 1, wherein the zoospore attractant is a C4-C8 aldehyde selected from the group consisting of isovaleraldehyde, 2-methylbutyraldehyde, valeraldehyde, isobutyraldehyde, butyraldehyde, 4-methylpentanal, 3,3-dimethylbutyraldehyde, 3-methylthiobutyraldehyde, 2-cyclopropylacetaldehyde, 3-methylcrotonaldehyde, 2-ethylcrotonaldehyde, crotonaldehyde, 2-methylcrotonaldehyde, furfural (2-furaldehyde), 2-thiophenecarboxaldehyde, 2-ethylbutyraldehyde, cyclopropanecarboxaldehyde, 2,3-dimethylvaleraldehyde, 2-methylvaleraldehyde, tetrahydrofuran-3-carboxaldehyde, and cyclopentanecarboxaldehyde.

19. The composition of claim 18, wherein the zoospore attractant is isovaleraldehyde, 2-methylbutyraldehdye, isobutyraldehyde, 3,3-dimethylbutyraldehyde, cyclopropylacetaldehyde, 3-methyl-2-butenaldehyde and valeraldehyde.

20. The composition of claim 19, wherein the zoospore attractant is isovaleraldehyde.

21. The composition of claim 18, wherein the zoospore attractant derivative is an aldehyde derivative selected from the group consisting of monohydrazones, bishydrazones, monoacylhydrazones, bisacylhydrazones, oximes, nitrones, enamines, acetals, a bisulfite addition compound and condensation products with urea.

22. The composition of claim 1, wherein the zoospore attractant is a C4-C8 carboxylic acid selected from the group consisting of isocaproic acid, isovaleric acid, valeric acid, caproic acid, cinnamic acid, their C1-C8 ester derivatives, and C2-C8 amino acids.

23. The composition of claim 22, wherein the C2-C8 amino acids are selected from the group consisting of L-asparagine, L-aspartate (L-aspartic acid), L-glutamate, L-glutamine, L-asparagine, L-alanine, arginine, leucine, and methionine.

24. The composition of claim 1, wherein the zoospore attractant is one of isoamyl alcohol, isoamyl amine, and an amide derivative of isoamyl amine.

25. The composition of claim 1, wherein the zoospore attractant is one of flavones and iso-flavones selected from the group consisting of cochliophilin A (5-hydroxy-6,7-methylenedioxyflavone), 4′-hydroxy-5,7-dihydroxyflavone, daidzein (7,4′-dihydroxyisoflavone), genistein (5,7,4′-trihydroxyisoflavone), 5,4′-dihydroxy-3,3′-dimethoxy-6,7-methylenedioxyflavone, prunetin (5,4′-dihydroxy-7-methoxyisoflavone), N-trans-feruloyl-4-O-methyldopamine, daidzin and genistin - carbohydrate conjugates, biochanin A, formononetin and isoformononetin.
